(19) United States
(12) Patent Application Publication
(10) Pub. No.: US 2006/0285180 A1
(43) Pub. Date: Dec. 21, 2006

(54) Imaging system and method

(76) Inventors: Troy Roberts, Loveland, CO (US); David R. Lawson, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/157,626

(22) Filed: Jun. 21, 2005

(51) Int. Cl. H04N 1/04

(52) U.S. Cl. 358/498; 358/474; 358/486

(57) ABSTRACT

An imaging system comprises a scanning device adapted to scan a front surface of a media object and an automatic document feeder (ADF) adapted to scan a back surface of the media object. The system also comprises a universal serial bus (USB) hub adapted to transfer data between the scanning device and the ADF to facilitate scanning of the media object.

### BACKGROUND OF THE INVENTION

Particular types of scanning systems are configured to scan both surfaces of a media object in a single pass. For example, these types of scanning systems generally comprise a scanning device for scanning a front surface of a media object and an automatic document feeder (ADF) for feeding the media object past the scanning device and scanning a back surface of the media object. However, communications and/or synchronization of the scanning operations between the scanning device and ADF generally require complex, costly, custom-designed application-specific integrated circuits and protocols.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a scanning device and an automatic document feeder (ADF) in which embodiments of the present invention may be incorporated in accordance with the present invention; and

FIG. 2 is diagram illustrating an embodiment of an imaging system in accordance with the present invention.

### DETAILED DESCRIPTION OF THE DRAWINGS

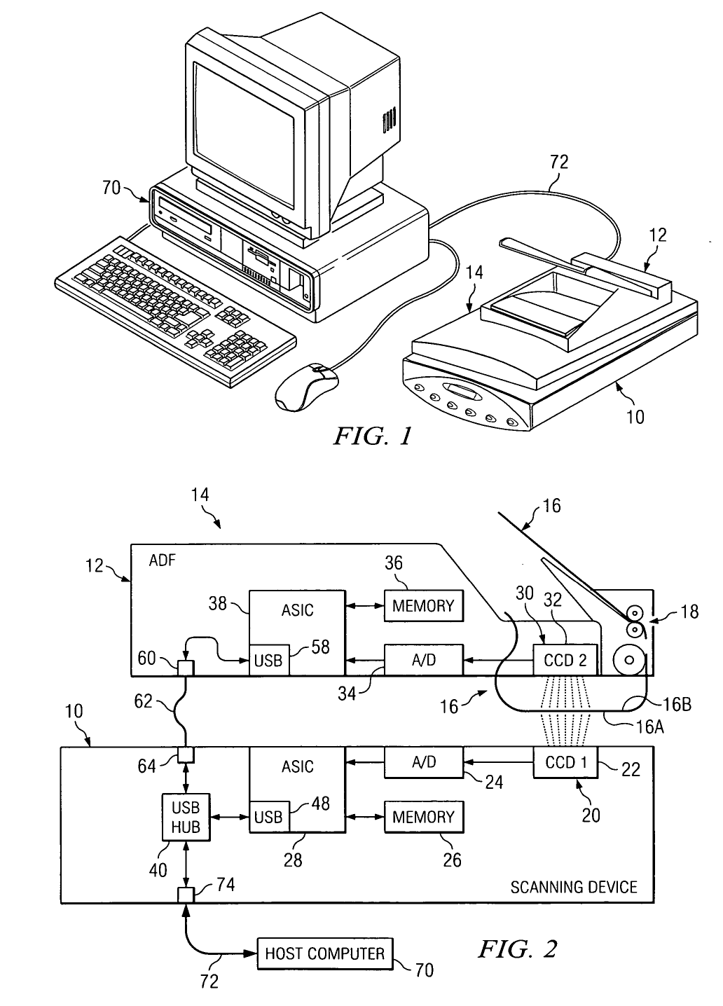

The preferred embodiments of the present invention and the advantages thereof are best understood by referring to FIGS. 1-3 of the drawings, like numerals being used for like and corresponding parts of the various drawings.

FIG. 1 is a diagram illustrating a scanning device 10 and an automatic document feeder (ADF) 12 in which embodiments of an imaging system 14 is incorporated in accordance with the teachings of the present invention, and FIG. 2 is a diagram illustrating an embodiment of imaging system 14 in accordance with the present invention. Scanning device 10 may comprise any type of device for performing a scanning operation to acquire and/or generate an image of a media object 16 such as, but not limited to, a scanner, copier, printer or facsimile device. ADF 12 comprises any device for automatically feeding media object(s) 16 to and/or past scanning device 10 and for performing a scanning operation to acquire and/or generate an image of an opposite side or surface of media object(s) 16. Media object(s) 16 may comprise any type of media element such as, but not limited to, a photograph, document, periodical, or any other type of object having text, graphics, or other types of visual content. In the embodiment illustrated in FIG. 2, ADF 12 comprises a feed assembly 18 for feeding media object(s) 16 to and/or past scanning device 10.

In the embodiment illustrated in FIG. 2, scanning device 10 comprises a photosensitive assembly 20 such as, but not limited to, a charge-coupled device (CCD) array 22, for receiving light reflected by and/or otherwise received from a front surface 16A of media object(s) 16 for generating a scanned image of front surface 16A of such media object(s) 16. In the embodiment illustrated in FIG. 2, scanning device 10 also comprises an analog-to-digital (A/D) converter 24 for converting analog signals to a digital signals, a memory 26, and an application-specific integrated circuit (ASIC) 28 for controlling and/or otherwise processing a scanning operation.

In the embodiment illustrated in FIG. 2, ADF 12 comprises a photosensitive assembly 30 such as, but not limited to, a charge-coupled device (CCD) array 32, for receiving light reflected by and/or otherwise received from a back or opposite surface 16B of media object(s) 16 for generating a scanned image of back surface 16B of such media object(s) 16. In the embodiment illustrated in FIG. 2, ADF 12 also comprises an analog-to-digital (A/D) converter 34 for converting analog signals to a digital signals, a memory 36, and an application-specific integrated circuit (ASIC) 38 for controlling and/or otherwise processing a scanning and/or feed operation of media object(s) 16.

In the embodiment illustrated in FIG. 2, scanning device 10 comprises a universal serial bus (USB) hub 40 for transferring data and/or otherwise facilitating communications between scanning device 10 and ADF 12 for performing a feed and/or scan operation relative to media object(s) 16. In the embodiment illustrated in FIG. 2, scanning circuits 28 and 38 of respective scanning device 10 and ADF 12 each comprise at least one USB port 48 and 58, respectively, for communicatively coupling respective scanning circuits 28 and 38 to USB hub 40. In the embodiment illustrated in FIG. 2, USB port 58 of scanning circuit 38 is communicatively coupled to USB hub 40 via a USB interface 60 (e.g., a port or connector element), a USB communication medium 62, and a USB interface 64 of scanning device 10 (e.g., a port or connector element). However, it should be understood that USB ports 48 and 58 may be otherwise communicatively coupled to USB hub 40, either directly or indirectly. In the embodiment illustrated in FIGS. 1 and 2, scanning device 10 is communicatively coupled to a remote host computer 70 via a USB communication medium 72 coupled to a USB interface 74 (e.g., a port or connector element) of scanning device 10. In the embodiment illustrated in FIG. 2, circuits 28 and 38 are illustrated as having a single USB port. However, it should be understood that circuits 28 and 38 may be configured with additional USB ports. Additionally, it should be understood that scanning device 10 and/or ADF 12 may be configured with additional USB interfaces (e.g., internal and/or external) for communicatively coupling respective scanning device 10 and/or ADF 12 to each other and/or other devices. Further, in the embodiment illustrated in FIG. 2, USB hub 40 is illustrated as being disposed within scanning device 10 and, correspondingly, scanning device 10 coupled to remote computer 70. However, it should be understood that USB hub 40 may be otherwise located (e.g., within ADF 12 with either ADF 12 and/or scanning device 12 directly coupled to host computer 70.

Thus, in operation, USB hub 40 provides data transfer between ADF 12 and scanning device 10, and between host computer 70 and scanning device 10 and/or ADF 12, via a USB protocol to facilitate the control and/or synchronization of a scanning operation relative to media object(s) 16 by scanning device 10 and/or host computer 70 without requiring custom-designed or custom-configured ASICs, proprietary interfaces and/or complex communication transceivers and signals, thereby enabling device 10 and/or ADF 12 to be configured using less expensive and/or off-the-shelf ASICs. For example, the data transferred via USB hub 40 may comprise status information, process interrupts, control signals for initiating a scan and/or feed of media object(s) 16, and/or other types of information associated with performing a scanning operation.

What is claimed is:

1. An imaging system, comprising:
a scanning device adapted to scan a surface of a media object;
an automatic document feeder (ADF) adapted to scan an opposite surface of the media object; and
a universal serial bus (USB) hub adapted to transfer data between the scanning device and the ADF to facilitate scanning of the media object.

2. The system of claim 1, wherein the USB hub is disposed within the scanning device.

3. The system of claim 1, wherein the USB hub is adapted to facilitate scanning synchronization of the media object between the scanning device and the ADF.

4. The system of claim 1, wherein the scanning device comprises a scanning circuit couplable to the USB hub.

5. The system of claim 1, wherein the ADF comprises a scanning circuit couplable to the USB hub.

6. The system of claim 1, wherein the scanning device comprises a scanning circuit having a USB port.

7. The system of claim 1, wherein the ADF comprises a scanning circuit having a USB port.

8. The system of claim 1, wherein the USB hub is couplable to a host computer.

9. An imaging system, comprising:
first means for scanning a surface of a media object;
second means for scanning an opposite surface of the media object; and
a universal serial bus (USB) means for transferring data between the first and second scanning means to facilitate scanning of the media object.

10. The system of claim 9, wherein the first means comprises a scanning circuit means couplable to the USB means.

11. The system of claim 9, wherein the second means comprises a scanning circuit means couplable to the USB means.

12. The system of claim 9, wherein the USB means is couplable to a host computer.

13. The system of claim 9, wherein the USB means is disposed in the first scanning means.

14. A method for producing an imaging system, comprising:
providing a scanning device for scanning a surface of a media object;
providing an automatic document feeder (ADF) for scanning an opposite surface of the media object; and
providing a universal serial bus (USB) hub adapted to transfer data between the scanning device and the ADF to facilitate scanning of the media object.

15. The method of claim 14, further comprising providing a scanning circuit in the scanning device couplable to the USB hub.

16. The method of claim 14, further comprising providing a scanning circuit in the ADF couplable to the USB hub.

17. The method of claim 14, wherein providing the USB hub comprises providing the USB being couplable to a host computer.

18. The method of claim 14, wherein providing the USB hub comprises providing the USB adapted to facilitate scanning synchronization of the media object between the scanning device and the ADF.

19. An imaging method, comprising:
transferring data between a scanning device and an automatic document feeder (ADF) for scanning of a media object via a universal serial bus (USB) hub, the scanning device scanning a surface of the media object, the ADF scanning an opposite surface of the media object.

20. The method of claim 19, wherein transferring data comprises transferring synchronization information between the scanning device and the ADF for scanning of the media object.

21. The method of claim 19, further comprising communicating data with the USB hub via a USB port of a scanning circuit of the scanning device.

22. The method of claim 19, further comprising communicating data with the USB hub via a USB port of a scanning circuit of the ADF.

23. A scanning device, comprising:
a scanning circuit adapted to control scanning of a surface of a media object; and
a universal serial bus (USB) hub adapted to transfer data between the scanning circuit and a scanning circuit of an automatic document feeder (ADF) to facilitate synchronizing a scan of an opposite surface of the media object by the ADF.

24. The scanning device of claim 23, wherein the scanning circuit of the scanning device comprises a USB port couplable to the USB hub.

25. The scanning device of claim 23, wherein the USB hub is couplable to a remote host computer.
